(19) United States
(12) Patent Application Publication
(10) Pub. No.: US 2018/0039811 A1
(43) Pub. Date: Feb. 8, 2018

(54) BIOMETRIC APPARATUS

(71) Applicant: Gingy Technology Inc., Hsinchu City (TW)

(72) Inventor: Chien-Hsing Wu, Hsinchu City (TW)

(73) Assignee: Gingy Technology Inc., Hsinchu City (TW)

(21) Appl. No.: 15/341,001

(22) Filed: Nov. 2, 2016

Related U.S. Application Data
(60) Provisional application No. 62/371,230, filed on Aug. 5, 2016.

(30) Foreign Application Priority Data
Aug. 23, 2016 (TW) 105126890

(51) Int. Cl. G06K 9/00

(52) U.S. Cl. CPC G06K 9/0004; G06K 9/00087

(57) ABSTRACT

A biometric apparatus including a light emitting device, an image capture device, a band pass filter, and a light scattering layer is provided. The light emitting device is used to emit a sensing light having a first wavelength range. The band pass filter is disposed on the image capture device. The light scattering layer is disposed on the band pass filter. A portion of any light having the first wavelength range is able to pass through the band pass filter, and the band pass filter is able to reflect a portion of any light having a second wavelength range. The first wavelength range and the second wavelength range are different.

### CROSS-REFERENCE TO RELATED APPLICATION

This application claims the priority benefits of U.S. provisional application Ser. No. 62/371,230, filed on Aug. 5, 2016, and Taiwan application serial no. 105126890, filed on Aug. 23, 2016. The entirety of each of the above-mentioned patent applications is hereby incorporated by reference herein and made a part of this specification.

### BACKGROUND OF THE INVENTION

### Field of the Invention

The invention relates to a biometric apparatus.

### Description of Related Art

The types of biometrics include face, voice, iris, retina, vein, and fingerprint identifications. Since each person's fingerprints are unique, and the fingerprints are not easy to change with age or health status, a fingerprint identification apparatus has become the most popular biometric apparatus at present. According to different sensing methods, the fingerprint identification apparatus may be further divided into an optical type, a capacitive type, an ultrasonic type, a thermal-sensing type, etc.

The working principle of the optical-type fingerprint identification apparatus is as follows. The fingerprint of a finger is composed of multiple irregular peaks and valleys. When the finger presses the fingerprint identification apparatus, the peaks are in contact with the fingerprint identification apparatus, and the valleys are not in contact with the fingerprint identification apparatus. A light beam will be directly reflected to an image capture device by the peaks, thereby forming a light region. At the same time, the light beam irradiated to the valleys will be reflected several times in the valleys and then transferred to the image capture device, thereby forming a dark region. Thereby, the light beam corresponding to the peaks and the valleys of the fingerprint forms a light and dark alternating fringe pattern on a light receiving surface of the image capture device, such that the image capture device obtains a fingerprint image. An algorithm is used to calculate information corresponding to the fingerprint image, so as to identify user identity.

In recent years, the biometric apparatus has been gradually combined with many electronic products (e.g., mobile phones, tablet computers, notebooks, flash drives), so as to be a checkpoint for safety protection apparatus. In order to match the appearance design of electronic products, a working surface of the biometric apparatus is required to be designed with a corresponding color. For example, the biometric apparatus may be applied to the mobile phone with a white border, and thus the working surface of the fingerprint identification apparatus needs to be designed to be white. The working surface of a conventional fingerprint identification apparatus is non-white, and the demand can not be met.

### SUMMARY OF THE INVENTION

The invention provides a biometric apparatus, of which a working surface represents a desired color.

The invention provides a biometric apparatus including a light emitting device, an image capture device, a band pass filter, and a light scattering layer. The light emitting device is used to emit a sensing light having a first wavelength range. The band pass filter is disposed on the image capture device. The light scattering layer is disposed on the band pass filter. A portion of any light having the first wavelength range is able to pass through the band pass filter, and the band pass filter is able to reflect a portion of any light having a second wavelength range. The first wavelength range and the second wavelength range are different.

According to an exemplary embodiment of the invention, the biometric apparatus is irradiated by an ambient light from outside of the biometric apparatus. A portion of the ambient light has the second wavelength range. The portion of the ambient light is reflected by the band pass filter and then passing through the light scattering layer, such that the biometric apparatus represents a color corresponding to the second wavelength range.

According to an exemplary embodiment of the invention, the sensing light is an infrared light. The portion of the ambient light is a visible light. The biometric apparatus represents white color.

According to an exemplary embodiment of the invention, the sensing light is an infrared light. The portion of the ambient light is a blue light. A red light and a green light of the ambient light are further able to pass through the band pass filter, and the biometric apparatus represents blue color.

According to an exemplary embodiment of the invention, the sensing light is an infrared light. The portion of the ambient light is a red light and a green light. A blue light of the ambient light is further able to pass through the band pass filter, and the biometric apparatus represents yellow color.

According to an embodiment of the invention, the light scattering layer has a haze H, and 10%≦H≦95%.

According to an exemplary embodiment of the invention, the light scattering layer has a transmittance T %, and 60%≦T %≦95%.

According to an exemplary embodiment of the invention, the biometric apparatus further includes a first substrate. The band pass filter, the first substrate and the light scattering layer are arranged toward a direction away from the image capture device sequentially.

According to an exemplary embodiment of the invention, the biometric apparatus further includes a second substrate. The second substrate, the band pass filter, the first substrate and the light scattering layer are arranged toward a direction away from the image capture device sequentially.

According to an exemplary embodiment of the invention, the biometric apparatus further includes a second substrate. The band pass filter, the second substrate, the first substrate and the light scattering layer are arranged toward a direction away from the image capture device sequentially.

According to an exemplary embodiment of the invention, the biometric apparatus further includes a second substrate. The band pass filter, the first substrate, the light scattering layer and the second substrate are arranged toward a direction away from the image capture device sequentially.

According to an exemplary embodiment of the invention, the biometric apparatus further includes a protective layer disposed on the light scattering layer.

Based on the above, the biometric apparatus of an embodiment of the invention includes the light emitting device, the image capture device, the band pass filter disposed on the image capture device, and the light scattering layer disposed on the band pass filter. The light emitting device is used to emit the sensing light having the first wavelength range. The portion of any light having the first wavelength range is able to pass through the band pass filter, and the band pass filter is able to reflect the portion of any light having the second wavelength range. By using filter and light-reflection characteristics of the band pass filter and using the band pass filter and the light scattering layer with each other, the working surface of the biometric apparatus is able to represent the desired color without excessively affecting image capture quality of biological features.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a biometric apparatus of an embodiment of the invention.

FIG. 2 is a partially enlarged schematic view of a biometric apparatus of an embodiment of the invention.

FIG. 3 is a schematic view of a transmission spectrum of a band pass filter of an embodiment of the invention.

FIG. 4 is a schematic view of a transmission spectrum of a band pass filter of another embodiment of the invention.

FIG. 5 is a schematic view of a transmission spectrum of a band pass filter of a further embodiment of the invention.

FIG. 6 is a schematic view of a biometric apparatus of another embodiment of the invention.

FIG. 7 is a schematic view of a biometric apparatus of a further embodiment of the invention.

FIG. 8 is a schematic view of a biometric apparatus of a further another embodiment of the invention.

FIG. 9 is a schematic view of a biometric apparatus of an embodiment of the invention.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

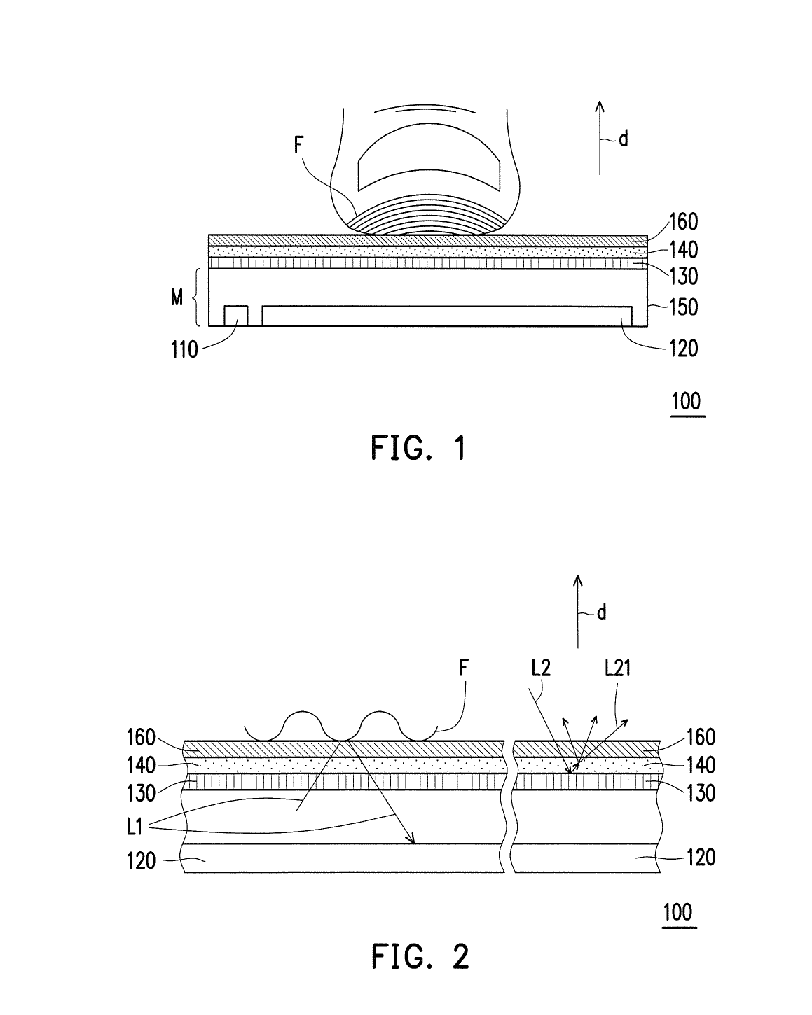

FIG. 1 is a schematic view of a biometric apparatus of an embodiment of the invention. FIG. 2 is a partially enlarged schematic view of a biometric apparatus of an embodiment of the invention. Referring to FIG. 1 and FIG. 2, a biometric apparatus 100 includes a light emitting device 110, an image capture device 120, a band pass filter 130, and a light scattering layer 140. As shown in FIG. 2, the light emitting device 110 is used to emit a sensing light L1 having a first wavelength range. For example, in the exemplary embodiment, the sensing light L1 may be a non-visible light. Furthermore, the sensing light L1 may be an infrared light, and the first wavelength range may be from 790 nanometers (nm) to 1000 nm. However, the invention is not limited thereto. In other exemplary embodiments, the wavelength range of the sensing light L1 may also be other suitable range. In the embodiment, the light emitting device 110 is a light emitting diode (LED), for example. However, the invention is not limited thereto. In other embodiments, the light emitting device 110 may also be other suitable type of light source. The light emitting device 110 and the image capture device 120 may be assembled in a same main body 150, thereby forming an image capture module M. However, the invention is not limited thereto. The light emitting device 110 may also be disposed at other suitable position.

Referring to FIG. 1 and FIG. 2, the light emitting device 110 emits the sensing light L1, and the sensing light L1 is used to irradiate a biological feature F. The image capture device 120 is used to receive the sensing light L1 reflected by the biological feature F, and transform the sensing light L1 into an electrical signal corresponding to the biological feature F. In the embodiment, the biological feature F is a fingerprint, for example. However, the invention is not limited thereto. In other embodiments, the biological feature may also be veins of a finger, an iris, a retina, or other biological features. In the embodiment, the image capture device 120 is a charge coupled device (CCD), a complementary metal-oxide semiconductor (CMOS), for example. However, the invention is not limited thereto. In other embodiments, the image capture device 120 may also be other suitable type of image sensor.

Referring to FIG. 1 and FIG. 2, the band pass filter 130 is disposed on the image capture device 120. The light scattering layer 140 is disposed on the band pass filter 130. The band pass filter 130 is located between the light scattering layer 140 and the image capture device 120. The light scattering layer 140 is closer to the biological feature F to be identified than the band pass filter 130. Particularly, a portion of any light having the first wavelength range is able to pass through the band pass filter 130, and the band pass filter 130 is able to reflect a portion of any light having a second wavelength range. The first wavelength range and the second wavelength range are different.

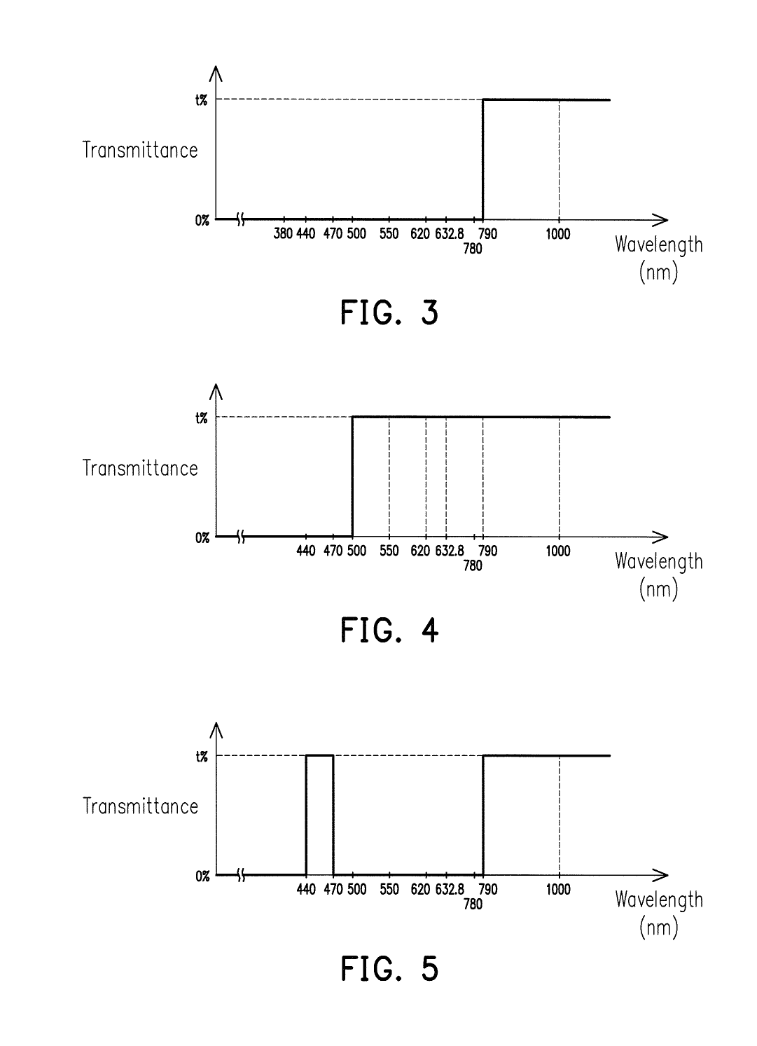

FIG. 3 is a schematic view of a transmission spectrum of a band pass filter of an embodiment of the invention. The transmittance t % shown in FIG. 3 is more than 0%. Referring to FIG. 1, FIG. 2, and FIG. 3, for example, in the embodiment, the first wavelength range which is able to pass through the band pass filter 130 may be from 790 nm to 1000 nm, and the second wavelength range which is reflected by the band pass filter 130 may be from 380 nm to 780 nm. As shown in FIG. 2, the sensing light L1 having the first wavelength range (e.g., 790 nm to 1000 nm) is able to pass through the band pass filter 130 and the light scattering layer 140 sequentially to irradiate the biological feature F. The sensing light L1 reflected by the biological feature F is also able to pass through the light scattering layer 140 and the band pass filter 130 sequentially, so as to transfer to the image capture device 120, such that the biometric apparatus 100 obtains image information corresponding to the biological feature F. On the other hand, if the biometric apparatus 100 is in a bright environment, an ambient light L2 (e.g., sunlight, artificial light) will irradiate the biometric apparatus 100, and pass through the light scattering layer 140, so as to transfer to the band pass filter 130. At this time, a portion L21 of the ambient light L2 (i.e., a visible light portion of the ambient light L2) having the second wavelength range (e.g., 380 nm to 780 nm) will be reflected by the band pass filter 130. The portion L21 of the ambient light L2 reflected by the band pass filter 130 will pass through the light scattering layer 140, and be scattered by the light scattering layer 140, such that the biometric apparatus 100 represents a color (e.g., white color) corresponding to the second wavelength range (e.g., 380 nm to 780 nm).

In short, by using filter and light-reflection characteristics of the band pass filter 130 and using the band pass filter 130 and the light scattering layer 140 with each other, the working surface of the biometric apparatus 100 is able to represent the desired color without excessively affecting the image capture quality of the biological feature F. It should be noted that, in the aforementioned embodiments, the working surface of the biometric apparatus 100 which represents white color is used as an example. However, the invention is not limited thereto. In other embodiments, by properly designing a transmission spectrum of the band pass filter 130, the working surface of the biometric apparatus 100 may also represent other colors. FIG. 4 and FIG. 5 are illustrated as an example in the following.

FIG. 4 is a schematic view of a transmission spectrum of a band pass filter of another embodiment of the invention. The transmittance t % shown in FIG. 4 is more than 0%. Referring to FIG. 1, FIG. 2, and FIG. 4, in another embodiment of the invention, not only the portion of any light having the first wavelength range (e.g., 790 nm to 1000 nm) is able to pass through the band pass filter 130, but a portion of any light having the wavelength range between 500 nm to 550 nm and a portion of any light having the wavelength range between 620 nm to 632.8 nm are able to pass through the band pass filter 130. The band pass filter 130 is able to reflect the portion of any light having the second wavelength range (e.g., 440 nm to 470 nm). In short, an infrared light, a green light, and a red light are able to pass through the band pass filter 130, and the band pass filter 130 is able to reflect a blue light. At this time, as shown in FIG. 2, the sensing light L1 having the first wavelength range (e.g., 790 nm to 1000 nm) is able to pass through the band pass filter 130 and the light scattering layer 140 sequentially to irradiate the biological feature F. The sensing light L1 reflected by the biological feature F is able to pass through the light scattering layer 140 and the band pass filter 130 sequentially, so as to transfer to the image capture device 120, such that the biometric apparatus 100 obtains the image information corresponding to the biological feature F. On the other hand, if the biometric apparatus 100 is in a bright environment, the ambient light L2 (e.g., sunlight, artificial light) will irradiate the biometric apparatus 100, and pass through the light scattering layer 140, so as to transfer to the band pass filter 130. At this time, the portion L21 of the ambient light L2 (i.e., the blue light portion of the ambient light L2) having the second wavelength range (e.g., 440 nm to 470 nm) will be reflected by the band pass filter 130. The portion L21 of the ambient light L2 reflected by the band pass filter 130 will pass through the light scattering layer 140, and be scattered by the light scattering layer 140, such that the biometric apparatus 100 represents blue color corresponding to the second wavelength range (e.g., 440 nm to 470 nm).

FIG. 5 is a schematic view of a transmission spectrum of a band pass filter of a further embodiment of the invention. The transmittance t % shown in FIG. 5 is more than 0%. Referring to FIG. 1, FIG. 2, and FIG. 5, in a further embodiment of the invention, not only the portion of any light having the first wavelength range (e.g., 790 nm to 1000 nm) is able to pass through the band pass filter 130, but also a portion of any light having the wavelength range between 440 nm to 470 nm is able to pass through the band pass filter 130. The band pass filter 130 is able to reflect the portion of any light having the second wavelength range (e.g., 500 nm to 550 nm and 620 nm to 632.8 nm). In short, an infrared light and a blue light are able to pass through the band pass filter 130, and the band pass filter 130 is able to reflect a green light and a red light. At this time, as shown in FIG. 2, the sensing light L1 having the first wavelength range (e.g., 790 nm to 1000 nm) is able to pass through the band pass filter 130 and the light scattering layer 140 sequentially to irradiate the biological feature F. The sensing light L1 reflected by the biological feature F is able to pass through the light scattering layer 140 and the band pass filter 130 sequentially, so as to transfer to the image capture device 120, such that the biometric apparatus 100 obtains the image information corresponding to the biological feature F. On the other hand, if the biometric apparatus 100 is in a bright environment, the ambient light L2 (e.g., sunlight, artificial light) will irradiate the biometric apparatus 100, and pass through the light scattering layer 140, so as to transfer to the band pass filter 130. At this time, the portion L21 of the ambient light L2 (i.e., the red light portion and the green light portion of the ambient light L2) having the second wavelength range (e.g., 500 nm to 550 nm and 620 nm to 632.8 nm) will be reflected by the band pass filter 130. The red light portion and the green light portion of the ambient light L2 reflected by the band pass filter 130 will be mixed to a yellow light and scattered by the light scattering layer 140, such that the biometric apparatus 100 represents yellow color corresponding to the second wavelength range (e.g., 500 nm to 550 nm and 620 nm to 632.8 nm).

Referring to FIG. 1 and FIG. 2, in the embodiment, the light scattering layer 140 has a haze H, and 10%≦H≦95%. The light scattering layer 140 has a transmittance T %, and 60%≦T %≦95%. In other words, the light scattering layer 140 has a low haze and a high transmittance. Thereby, a transmission path of the sensing light L1 is not easy to be excessively influenced by the light scattering layer 140. Then, an image of the biological feature F with good quality (i.e., image sharpness is high) can be obtained when the working surface of the biometric apparatus 100 represents the desired color.

Referring to FIG. 1 and FIG. 2, in the embodiment, the biometric apparatus 100 may further include a protective layer 160. The protective layer 160 is disposed on the light scattering layer 140. The band pass filter 130, the light scattering layer 140, and the protective layer 160 are arranged toward a direction d away from the image capture device 120 sequentially. The protective layer 160 is closest to the biological feature F. The protective layer 160 can protect the light scattering layer 140 and/or the band pass filter 130 from scratching. In the embodiment, the protective layer 160 is a light transmissive hard coating, for example. However, the invention is not limited thereto. In other embodiments, the protective layer 160 may also be a light transmissive plate or other suitable device.

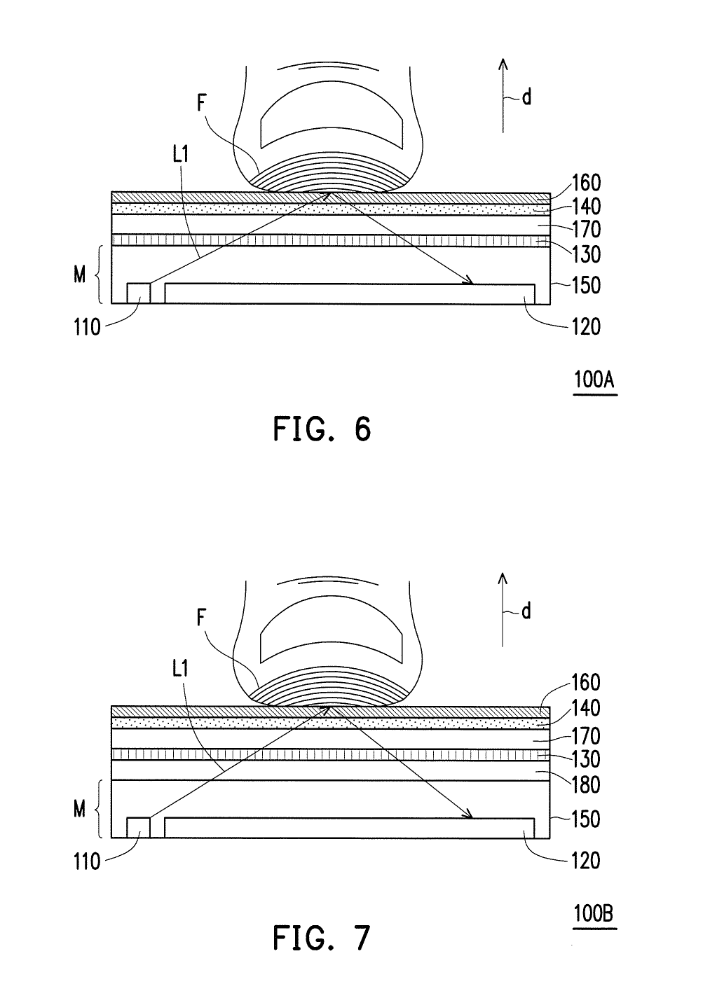

FIG. 6 is a schematic view of a biometric apparatus of another exemplary embodiment of the invention. A biometric apparatus 100A of FIG. 6 is similar to the biometric apparatus 100 of FIG. 1, and thus the same or corresponding components are represented by the same or corresponding reference numbers. The difference between the biometric apparatus 100A and the biometric apparatus 100 is that, the biometric apparatus 100A further includes a first substrate 170. The difference between the two is mainly illustrated in the following, and the same or corresponding positions of the two are referred to the above illustrations.

Referring to FIG. 6, the biometric apparatus 100A includes the light emitting device 110, the image capture device 120, the band pass filter 130, and the light scattering layer 140. The light emitting device 110 is used to emit the sensing light L1 having the first wavelength range. The band pass filter 130 is disposed on the image capture device 120. The light scattering layer 140 is disposed on the band pass filter 130. The portion of any light having the first wavelength range is able to pass through the band pass filter 130, and the band pass filter 130 is able to reflect the portion of any light having the second wavelength range. The first wavelength range and the second wavelength range are different. The difference between the biometric apparatus 100A and the biometric apparatus 100 is that, the biometric apparatus 100A further includes the first substrate 170. The first substrate 170 is a light transmissive substrate. The band pass filter 130, the first substrate 170, the light scattering layer 140, and the protective layer 160 are arranged toward the direction d away from the image capture device 120 sequentially. The biometric apparatus 100A have the effects and advantages similar to the biometric apparatus 100, and are not repeated herein.

FIG. 7 is a schematic view of a biometric apparatus of a further embodiment of the invention. A biometric apparatus 100B of FIG. 7 is similar to the biometric apparatus 100 of FIG. 1, and thus the same or corresponding components are represented by the same or corresponding reference numbers. The difference between the biometric apparatus 100B and the biometric apparatus 100 is that, the biometric apparatus 100B further includes the first substrate 170 and a second substrate 180. The difference between the two is mainly illustrated in the following, and the same or corresponding positions of the two are referred to the above illustrations.

Referring to FIG. 7, the biometric apparatus 100B includes the light emitting device 110, the image capture device 120, the band pass filter 130, and the light scattering layer 140. The light emitting device 110 is used to emit the sensing light L1 having the first wavelength range. The band pass filter 130 is disposed on the image capture device 120. The light scattering layer 140 is disposed on the band pass filter 130. The portion of any light having the first wavelength range is able to pass through the band pass filter 130, and the band pass filter 130 is able to reflect the portion of any light having the second wavelength range. The first wavelength range and the second wavelength range are different. The difference between the biometric apparatus 100B and the biometric apparatus 100 is that, the biometric apparatus 100B further includes the first substrate 170 and the second substrate 180. The first substrate 170 and the second substrate 180 are light transmissive substrates. The second substrate 180, the band pass filter 130, the first substrate 170, the light scattering layer 140, and the protective layer 160 are arranged toward the direction d away from the image capture device 120 sequentially. The biometric apparatus 100B have the effects and advantages similar to the biometric apparatus 100, and are not repeated herein.

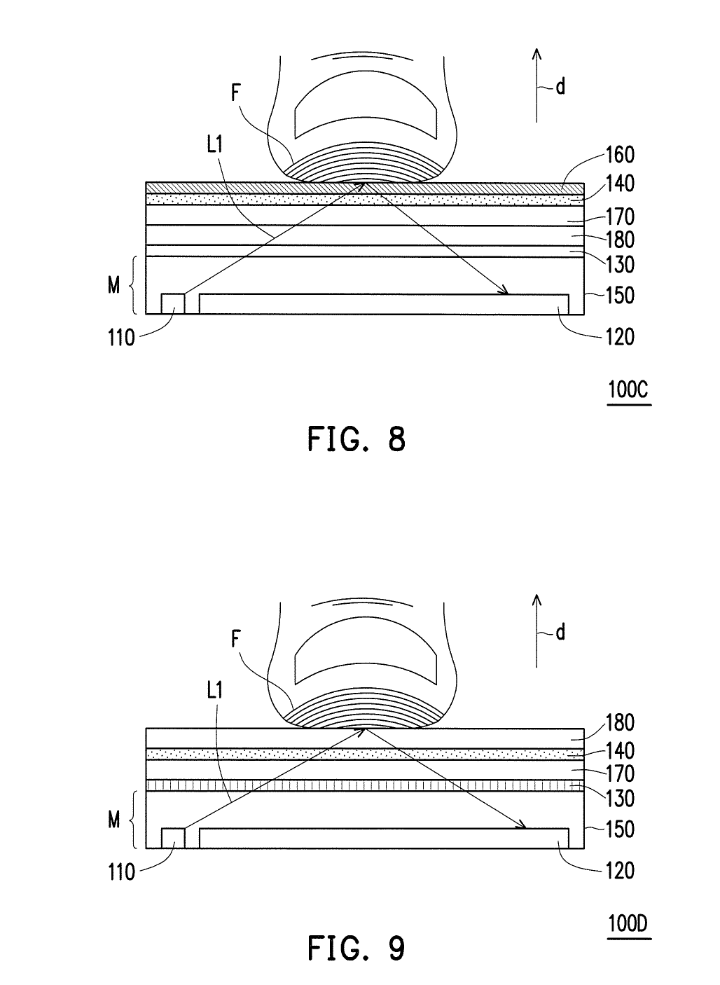

FIG. 8 is a schematic view of a biometric apparatus of a further another embodiment of the invention. A biometric apparatus 100C of FIG. 8 is similar to the biometric apparatus 100 of FIG. 1, and thus the same or corresponding components are represented by the same or corresponding reference numbers. The difference between the biometric apparatus 100C and the biometric apparatus 100 is that, the biometric apparatus 100C further includes the first substrate 170 and the second substrate 180. The difference between the two is mainly illustrated in the following, and the same or corresponding positions of the two are referred to the above illustrations.

Referring to FIG. 8, the biometric apparatus 100C includes the light emitting device 110, the image capture device 120, the band pass filter 130, and the light scattering layer 140. The light emitting device 110 is used to emit the sensing light L1 having the first wavelength range. The band pass filter 130 is disposed on the image capture device 120. The light scattering layer 140 is disposed on the band pass filter 130. The portion of any light having the first wavelength range is able to pass through the band pass filter 130, and the band pass filter 130 is able to reflect the portion of any light having the second wavelength range. The first wavelength range and the second wavelength range are different. The difference between the biometric apparatus 100C and the biometric apparatus 100 is that, the biometric apparatus 100C further includes the first substrate 170 and the second substrate 180. The first substrate 170 and the second substrate 180 are light transmissive substrates. The band pass filter 130, the second substrate 180, the first substrate 170, the light scattering layer 140, and the protective layer 160 are arranged toward the direction d away from the image capture device 120 sequentially. The biometric apparatus 100C have effects and advantages similar to the biometric apparatus 100, and are not repeated herein.

FIG. 9 is a schematic view of a biometric apparatus of an embodiment of the invention. A biometric apparatus 100D of FIG. 9 is similar to the biometric apparatus 100 of FIG. 1, and thus the same or corresponding components are represented by the same or corresponding reference numbers. The difference between the biometric apparatus 100D and the biometric apparatus 100 is that, the biometric apparatus 100D further includes the first substrate 170 and the second substrate 180. The difference between the two is mainly illustrated in the following, and the same or corresponding positions of the two are referred to the above illustrations.

Referring to FIG. 9, the biometric apparatus 100D includes the light emitting device 110, the image capture device 120, the band pass filter 130, and the light scattering layer 140. The light emitting device 110 is used to emit the sensing light L1 having the first wavelength range. The band pass filter 130 is disposed on the image capture device 120. The light scattering layer 140 is disposed on the band pass filter 130. The portion of any light having the first wavelength range is able to pass through the band pass filter 130, and the band pass filter 130 is able to reflect the portion of any light having the second wavelength range. The first wavelength range and the second wavelength range are different. The difference between the biometric apparatus 100D and the biometric apparatus 100 is that, the biometric apparatus 100D further includes the first substrate 170 and the second substrate 180. The first substrate 170 and the second substrate 180 are light transmissive substrates. The band pass filter 130, the first substrate 170, the light scattering layer 140, and the second substrate 180 are arranged toward the direction d away from the image capture device 120 sequentially. The second substrate 180 can replace the function of the protective layer 160, and the protective layer 160 may be not disposed at the biometric apparatus 100D selectively. The biometric apparatus 100D have effects and advantages similar to the biometric apparatus 100, and are not repeated herein.

In summary, the biometric apparatus of an embodiment of the invention includes the light emitting device, the image capture device, the band pass filter disposed on the image capture device, and the light scattering layer disposed on the band pass filter. The light emitting device is used to emit the sensing light having the first wavelength range. The portion of any light having the first wavelength range is able to pass through the band pass filter, and the band pass filter is able to reflect the portion of any light having the second wavelength range. By using filter and light-reflection characteristics of the band pass filter and using the band pass filter and the light scattering layer with each other, the working surface of the biometric apparatus is able to represent the desired color without excessively affecting the image capture quality of the biological features.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A biometric apparatus, comprising:
a light emitting device, used to emit a sensing light having a first wavelength range;
an image capture device;
a band pass filter, disposed on the image capture device; and
a light scattering layer, disposed on the band pass filter, wherein a portion of any light having the first wavelength range is able to pass through the band pass filter, the band pass filter is able to reflect a portion of any light having a second wavelength range, and the first wavelength range and the second wavelength range are different.

2. The biometric apparatus according to claim 1, wherein a portion of an ambient light has the second wavelength range, the portion of the ambient light is reflected by the band pass filter and then passing through the light scattering layer, such that the biometric apparatus represents a color corresponding to the second wavelength range.

3. The biometric apparatus according to claim 2, wherein the sensing light is an infrared light, the portion of the ambient light is a visible light, and the biometric apparatus represents white color.

4. The biometric apparatus according to claim 2, wherein the sensing light is an infrared light, the portion of the ambient light is a blue light, a red light and a green light of the ambient light are further able to pass through the band pass filter, and the biometric apparatus represents blue color.

5. The biometric apparatus according to claim 2, wherein the sensing light is an infrared light, the portion of the ambient light is a red light and a green light, a blue light of the ambient light is further able to pass through the band pass filter, and the biometric apparatus represents yellow color.

6. The biometric apparatus according to claim 1, wherein the light scattering layer has a haze H, and 10%≦H≦95%.

7. The biometric apparatus according to claim 1, wherein the light scattering layer has a transmittance T %, and 60%≦T %≦95%.

8. The biometric apparatus according to claim 1, further comprising:
a first substrate, wherein the band pass filter, the first substrate and the light scattering layer are arranged toward a direction away from the image capture device sequentially.

9. The biometric apparatus according to claim 8, further comprising:
a second substrate, wherein the second substrate, the band pass filter, the first substrate and the light scattering layer are arranged toward a direction away from the image capture device sequentially.

10. The biometric apparatus according to claim 8, further comprising:
a second substrate, wherein the band pass filter, the second substrate, the first substrate and the light scattering layer are arranged toward a direction away from the image capture device sequentially.

11. The biometric apparatus according to claim 8, further comprising:
a second substrate, wherein the band pass filter, the first substrate, the light scattering layer and the second substrate are arranged toward a direction away from the image capture device sequentially.

12. The biometric apparatus according to claim 1, further comprising: a protective layer, disposed on the light scattering layer.

13. The biometric apparatus according to claim 8, further comprising: a protective layer, disposed on the light scattering layer.

14. The biometric apparatus according to claim 9, further comprising: a protective layer, disposed on the light scattering layer.

15. The biometric apparatus according to claim 10, further comprising: a protective layer, disposed on the light scattering layer.

16. The biometric apparatus according to claim 11, further comprising: a protective layer, disposed on the light scattering layer.
